(19) United States
(12) Patent Application Publication
(10) Pub. No.: US 2024/0042817 A1
(43) Pub. Date: Feb. 8, 2024

(54) Tow Hitch Cover Device

(71) Applicant: Jason Leon, Sparks, NV (US)

(72) Inventor: Jason Leon, Sparks, NV (US)

(21) Appl. No.: 18/302,558

(22) Filed: Apr. 18, 2023

Related U.S. Application Data
(60) Provisional application No. 63/394,382, filed on Aug. 2, 2022.

(51) Int. Cl. B60D 1/60

(52) U.S. Cl. CPC B60D 1/605

(57) ABSTRACT

The present invention relates to a tow hitch cover device. The device has a cover that can be placed over the ball of a tow hitch and resembles a face. The cover is then enclosed by both halves of a helmet assembly. The helmet assembly further attaches to the cover via fasteners. As a result, the cover and helmet assembly combine to form the image of a football player wearing a helmet.

### CROSS-REFERENCE TO RELATED APPLICATION

The present application claims priority to, and the benefit of, U.S. Provisional Application No. 63/394,382, which was filed on Aug. 2, 2022, and is incorporated herein by reference in its entirety.

### FIELD OF THE INVENTION

The present invention relates generally to the field of tow hitch ball covers. More specifically, the present invention relates to a tow hitch cover device. The device has a cover that can be placed over the ball of a tow hitch and resembles a face. The cover is then enclosed by both halves of a helmet assembly. The helmet assembly further attaches to the cover via fasteners. As a result, the cover and helmet assembly combine to form the image of a football player wearing a helmet. Accordingly, the present disclosure makes specific reference thereto. Nonetheless, it is to be appreciated that aspects of the present invention are also equally applicable to other like applications, devices, and methods of manufacture.

### BACKGROUND

Many trucks and vehicles have tow hitches. When not in use, a tow hitch is exposed to the surrounding environment. This may allow weather to rust the tow hitch, which is undesirable and may compromise the structural integrity of the hitch. In addition, many individuals may find an exposed tow hitch visually unappealing. Further, existing tow hitch covers are often simple and visually unappealing.

Therefore, there exists a long-felt need in the art for a tow hitch cover. There also exists a long-felt need in the art for a tow hitch cover device that protects an exposed tow hitch from the weather. Further, there exists a long-felt need in the art for a tow hitch cover device that makes a tow hitch visually appealing.

The subject matter disclosed and claimed herein, in one embodiment thereof, comprises a tow hitch cover device. The device is primarily comprised of a cover with at least one facial feature and at least one fastener, and a helmet assembly with a first half and a second half. The cover is placed over the ball of a tow hitch and resembles a face. The cover is then enclosed by both halves of the helmet assembly. The helmet assembly further attaches to the cover via fasteners. As a result, the cover and helmet assembly combine to form the image of a football player wearing a helmet.

In this manner, the tow hitch cover device of the present invention accomplishes all of the foregoing objectives and provides a novel tow hitch cover that is visually appealing. While being visually appealing, the device also protects an exposed tow hitch from the weather.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a tow hitch cover device. The device is primarily comprised of a cover with at least one facial feature and at least one fastener, and a helmet assembly with a first half and a second half. The cover is spherical in shape and is comprised of a bottom opening that allows the cover to stretch over a tow hitch ball such that the cover encloses the ball. The cover is made from an elastic material that is preferably waterproof and UV-resistant.

The cover is intended to resemble a face. Accordingly, the cover is preferably skin-colored and has at least one facial feature such as, but not limited to, an eye, a nose, a mouth, a tooth, an eyebrow, eye black, etc., such that the cover resembles the face of a human. The facial features may specifically be shaped to represent a specific individual such as, but not limited to, a football player, a coach, an owner, a manager, a team mascot, etc.

The helmet assembly removably attaches around the cover using a first half that attaches to the second half around the cover. Both halves are preferably made from a rigid, waterproof, and UV-resistant plastic material. The outer surface of each half is preferably comprised of at least one indicia such as, but not limited to, a team logo such that the helmet assembly resembles the helmet aesthetics of a specific team.

The inner edge of each half of the helmet assembly is further comprised of at least one fastener such that both halves can be secured to each other around the cover after the cover has been placed over a ball. Each half also has a face mask, further comprised of at least one fastener such that both halves can be secured to each other around the cover after the cover has been placed over a ball. To further secure the helmet assembly to the cover, the outer surface of the cover is comprised of at least one fastener that engages a reciprocating fastener positioned on the inner surface of each half of the helmet assembly.

Accordingly, the tow hitch cover device of the present invention is particularly advantageous as it provides an improved tow hitch cover. The device protects an exposed tow hitch from the weather. While doing so, the device also makes a tow hitch visually appealing. In this manner, the tow hitch cover device overcomes the limitations of existing tow hitch covers known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front view of one potential embodiment of a tow hitch cover device of the present invention while attached to a tow hitch ball in accordance with the disclosed architecture;

FIG. 2 illustrates a front exploded view of one potential embodiment of a tow hitch cover device of the present invention in accordance with the disclosed architecture; and

FIG. 3 illustrates a perspective view of one potential embodiment of a tow hitch cover device of the present invention while attached to a tow hitch ball in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a tow hitch cover. There also exists a long-felt need in the art for a tow hitch cover device that protects an exposed tow hitch from the weather. Further, there exists a long-felt need in the art for a tow hitch cover device that makes a tow hitch visually appealing.

The present invention, in one exemplary embodiment, is comprised of a tow hitch cover device primarily comprised of a cover with at least one facial feature and at least one fastener, and a helmet assembly with a first half and a second half. The cover is spherical in shape and is comprised of a bottom opening that allows the cover to stretch over a tow hitch ball such that the cover encloses the ball. The cover is made from an elastic material that is preferably waterproof and UV-resistant.

The cover is intended to resemble a face and is preferably skin-colored and has at least one facial feature such as, but not limited to, an eye, a nose, a mouth, a tooth, an eyebrow, eye black, etc., such that the cover resembles the face of a human. The facial features may specifically be shaped to represent a specific individual such as, but not limited to, a football player, a coach, an owner, a manager, a team mascot, etc.

The helmet assembly removably attaches around the cover using a first half that attaches to the second half around the cover. Both halves are preferably made from a rigid, waterproof, and UV-resistant plastic material. The outer surface of each half is preferably comprised of at least one indicia such as, but not limited to, a team logo such that the helmet assembly resembles the helmet aesthetics of a specific team.

The inner edge of each half of the helmet assembly is further comprised of at least one fastener. Therefore, both halves can be secured to each other around the cover after the cover has been placed over a ball. Each half also has a face mask, further comprised of at least one fastener such that both halves can be secured to each other around the cover after the cover has been placed over a ball. To further secure the helmet assembly to the cover, the outer surface of the cover is comprised of at least one fastener that engages a reciprocating fastener positioned on the inner surface of each half of the helmet assembly.

Accordingly, the tow hitch cover device of the present invention is particularly advantageous as it provides an improved tow hitch cover. The device protects an exposed tow hitch from the weather. While doing so, the device also makes a tow hitch visually appealing. In this manner, the tow hitch cover device overcomes the limitations of existing tow hitch covers known in the art.

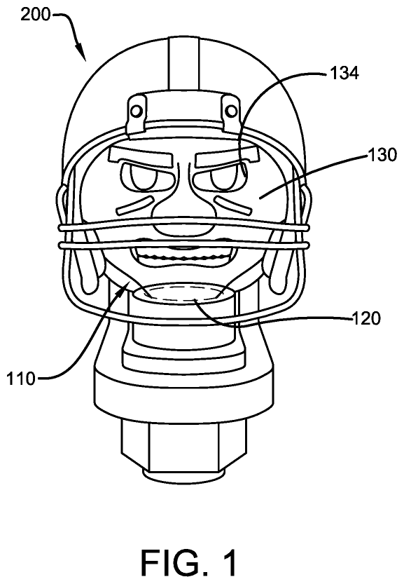

Referring initially to the drawings, FIG. 1 illustrates a front view of one potential embodiment of a tow hitch cover device 100 of the present invention while attached to a tow hitch ball 10 in accordance with the disclosed architecture. The device 100 is primarily comprised of a cover 110 with at least one facial feature 134 and at least one fastener 132, and a helmet assembly 200 with a first half 210 and a second half 310. The cover 110 is spherical in shape and is comprised of a bottom opening 120. The bottom opening 120 allows the cover 110 to be stretched over a tow hitch ball 10 such that the cover 110 encloses the ball 10. The cover 110 is made from an elastic material that is preferably waterproof and UV-resistant rubber such as, but not limited to, natural rubbers, neoprene rubber elastomer, silicone rubber elastomer, ethylene propylene diene monomer rubber, butyl rubber, nitrile rubber, buna-n rubber, styrene-butadiene rubber elastomers, Viton rubber elastomer, diaphragm rubber, thermoplastic rubber, etc. In differing embodiments, the cover 110 may be any size in order to accommodate and enclose a plurality of tow hitch ball 10 sizes. However, in the preferred embodiment the cover 110 can stretch over a plurality of tow hitch ball 10 sizes due to its elastic properties.

The cover 110 is intended to resemble a face. Accordingly, the cover 110 is preferably skin-colored. However, the cover 110 may be any color in various embodiments. The outer surface 130 of the cover is comprised of at least one facial feature 134 such as, but not limited to, an eye, a nose, a mouth, a tooth, an eyebrow, eye black, etc., such that the cover 110 resembles the face of a human. The facial features 134 may specifically be shaped to represent a specific individual such as, but not limited to, a football player, a coach, an owner, a manager, a team mascot, etc.

The helmet assembly 200 removably attaches around the cover 110 such that the cover 110 is enclosed by the assembly 200. The helmet assembly 200 has a first half 210 that attaches to the second half 310 around the cover 110. Both halves 210,310 are preferably made from a rigid, waterproof, and UV-resistant plastic material such as, but not limited to, acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc. The outer surface 250,350 of each half 210,310 is preferably comprised of at least one indicia 252. The indicia 252 is preferably a team logo such that the helmet assembly 200 resembles the helmet aesthetics of a specific team. However, the indicia 252 may be any indicia such as, but not limited to, patterns, logos, emblems, images, symbols, designs, letters, numbers, words, characters, animals, advertisements, brands, etc. In one embodiment, the indicia 252 is a sticker that can be applied to the helmet assembly 200.

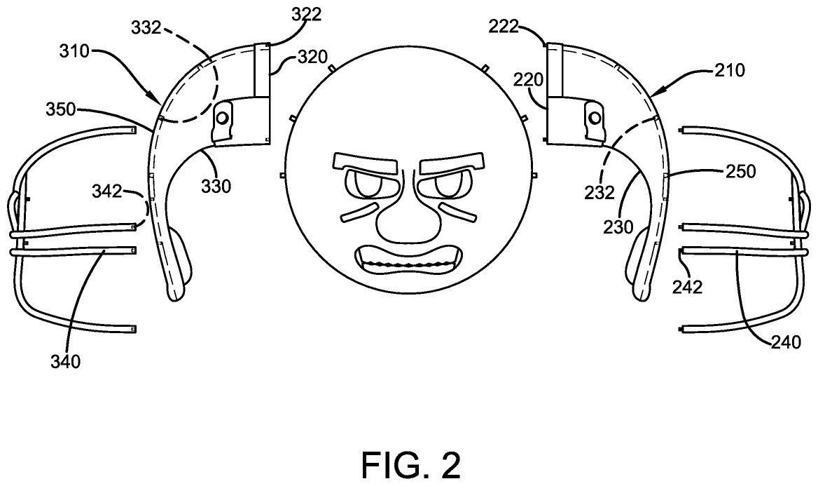

FIG. 2 illustrates a front exploded view of one potential embodiment of a tow hitch cover device 100 of the present invention in accordance with the disclosed architecture. The inner edge 220,320 of each half 210,310 is further comprised of at least one fastener 222,322. In the preferred embodiment, the fasteners 222,322 are reciprocating fasteners such as, but not limited to, a male fastener 222 and a female fastener 322. However, the fasteners 222,322 may be any reciprocating fastener type known in the art such as, but not limited to, tongue and groove, hook and loop, snap button, magnetic, adhesive, etc. In this manner, both halves 210,310 can be secured to each other 210,310 around the cover 110 after the cover has been placed over a ball 10.

Each half 210,310 also has a face mask 240,340, further comprised of at least one fastener 242,342. In the preferred embodiment, the fasteners 242,342 are reciprocating fasteners such as, but not limited to, a male fastener 242 and a female fastener 342. However, the fasteners 242,342 may be any reciprocating fastener type known in the art such as, but not limited to, tongue and groove, hook and loop, snap button, magnetic, adhesive, etc. In this manner, both halves 210,310 (and the face mask 240,340 of each half 210,310) can be secured to each other 210,310 around the cover 110 after the cover has been placed over a ball 10. In one embodiment, the fasteners 242,342 may additionally engage at least one fastener 232,332 positioned on the outer surface 250,350 for further securing.

To further secure the helmet assembly 200 to the cover 110, the outer surface 130 of the cover 110 is comprised of at least one fastener 132. The fastener 132 engages a reciprocating fastener 232,332 positioned on the inner surface 230,330 of each half 210,310 of the helmet assembly 200. In the preferred embodiment, the fasteners 132 and 232,332 are reciprocating fasteners such as, but not limited to, a male fastener 132 and a female fastener 232,332. However, the fasteners 132 and 232,332 may be any reciprocating fastener type known in the art such as, but not limited to, tongue and groove, hook and loop, snap button, magnetic, adhesive, etc. In this manner, both halves 210,310 can be secured to each other 210,310 around the cover 110 after the cover has been placed over a ball 10.

As result, the device 100 allows a user to display their loyalty to their favorite football team. While doing so, their tow hitch ball 10 remains protected. It should be appreciated that in differing embodiments, the cover 110 may resemble any human, animal, object, etc., and is not limited to a football player or related person. Said embodiment may or may not include the helmet assembly 200.

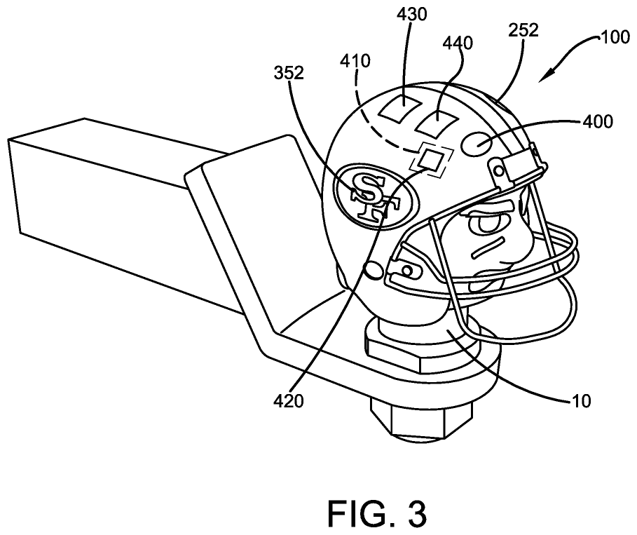

FIG. 3 illustrates a perspective view of one potential embodiment of a tow hitch cover device 100 of the present invention while attached to a tow hitch ball 10 in accordance with the disclosed architecture. In one embodiment, the cover 110 and/or helmet assembly 200 may be comprised of at least one light source 400, which is preferably, but not limited to, an LED light. The light source 400 illuminates the helmet assembly 200 and/or cover 110 at night and may be positioned anywhere internally and externally on/in the cover 110 and/or helmet assembly 200. The light source 400 may be automatically activated by at least one light sensor 440, wherein the light sensor is activated when an amount of light is detected below a threshold value (i.e., such that the light source 400 is activated between dusk and dawn). In one embodiment, the light source 400 is powered by at least one battery 410. The battery 410 may be a disposable battery 410 or a rechargeable battery 410 in the form of an alkaline, nickel-cadmium, nickel-metal hydride battery 410, etc., such as any 3V-12 volts DC battery 410 or other conventional battery 410 such as A, AA, AAA, etc., that supplies power to the device 100. Throughout this specification the terms “battery” and “batteries” may be used interchangeably to refer to one or more wet or dry cells or batteries 410 of cells in which chemical energy is converted into electricity and used as a source of DC power. References to recharging or replacing batteries 410 may refer to recharging or replacing individual cells, individual batteries 410 of cells, or a package of multiple battery cells as is appropriate for any given battery 410 technology that may be used. Additionally, the battery 410 may be recharged by a USB port 420. In a differing embodiment, the battery 410 is recharged by at least one solar panel 430 positioned on the helmet assembly 200. In differing embodiments of the device 100, the solar panel 430 may be comprised of, but not limited to, monocrystalline silicon, polycrystalline silicon, or a photovoltaic cell film.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “tow hitch cover device” and “device” are interchangeable and refer to the tow hitch cover device 100 of the present invention.

Notwithstanding the foregoing, the tow hitch cover device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the tow hitch cover device 100 as shown in the FIGS. are for illustrative purposes only, and that many other sizes and shapes of the tow hitch cover device 100 are well within the scope of the present disclosure. Although the dimensions of the tow hitch cover device 100 are important design parameters for user convenience, the tow hitch cover device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A tow hitch cover device comprising:
a core having a facial feature; and
a helmet assembly comprised of:
a first half comprised of a first fastener positioned on a first inner edge, a first facemask comprised of a second fastener, and a first indicia; and
a second half comprised of a third fastener positioned on a second inner edge, a second facemask comprised of a fourth fastener, and a second indicia.

2. The tow hitch cover device of claim 1, wherein the helmet assembly is comprised of a rigid, a waterproof, and a UV-resistant plastic.

3. The tow hitch cover device of claim 1, wherein the core is comprised of an elastic, a waterproof, and a UV-resistant rubber material.

4. The tow hitch cover device of claim 1, wherein the first indicia and the second indicia are comprised of a team logo.

5. A tow hitch cover device comprising:
a core comprised having a facial feature comprised of a pair of eyes, a nose, a mouth and a pair of eyebrows; and
a helmet assembly comprised of:
a first half comprised of a first fastener positioned on a first inner edge, a first facemask comprised of a second fastener, and a first indicia; and
a second half comprised of a third fastener positioned on a second inner edge, a second facemask comprised of a fourth fastener, and a second indicia.

6. The tow hitch cover device of claim 5, wherein each of the first indicia and the second indicia are comprised of a sticker.

7. The tow hitch cover device of claim 5, wherein the core is comprised of a set of eye black.

8. The tow hitch cover device of claim 5, wherein the first fastener and the second fastener are a male fastener.

9. The tow hitch cover device of claim 5, wherein the third fastener and the fourth fastener is a female fastener.

10. A tow hitch cover device comprising:
a core having a facial feature comprised of a pair of eyes, a nose, a mouth and a pair of eyebrows;
a helmet assembly comprised of:
a first half comprised of a first fastener positioned on a first inner edge, a first facemask comprised of a second fastener, and a first indicia;
a second half comprised of a third fastener positioned on a second inner edge, a second facemask comprised of a fourth fastener, and a second indicia;
a light source;
a solar panel; and
a battery.

11. The tow hitch cover device of claim 10, wherein an outer surface of the core is comprised of a fifth fastener.

12. The tow hitch cover device of claim 11, wherein the fifth fastener is a male fastener.

13. The tow hitch cover device of claim 11, wherein the fifth fastener is received by a sixth fastener of a first inner surface of the first half.

14. The tow hitch cover device of claim 13, wherein the sixth fastener is a female fastener.

15. The tow hitch cover device of claim 11, wherein the fifth fastener is received by a seventh fastener of a second inner surface of the second half.

16. The tow hitch cover device of claim 15, wherein the seventh fastener is a female fastener.

17. The tow hitch cover device of claim 10, wherein the solar panel provides power to the battery.

18. The tow hitch cover device of claim 17, wherein the battery powers the light source.

19. The tow hitch cover device of claim 18, wherein the light source is activated by a light sensor.

20. The tow hitch cover device of claim 19, wherein the light sensor is activated when an amount of light is detected below a threshold value.
